(19) United States
(12) Patent Application Publication
(10) Pub. No.: US 2006/0272524 A1
(43) Pub. Date: Dec. 7, 2006

(54) Credit card imprinter

(76) Inventors: Sotirios Stefanos Naoumis, Karditsa (GR); Mattheos Stefanos Naoumis, Karditsa (GR)

Correspondence Address: LADAS & PARRY, 26 WEST 61ST STREET, NEW YORK, NY, 10023, US

(21) Appl. No.: 11/152,676

(22) Filed: Jun. 14, 2005

(30) Foreign Application Priority Data
Jun. 1, 2005 (GR) 20050100280

(51) Int. Cl. B41F 3/04

(52) U.S. Cl. 101/269; 101/56; 101/45

(57) ABSTRACT

The invention is a credit card imprinter for use in imprinting formsets with embossed characters from a credit card and a merchant plate.

The invention consists of a flatbed (1), attached to a skirt (2), which extends peripherally outside the flatbed to form a unitary structure and an imprinting head (5), moving in a reciprocal motion across the top surface of the flatbed, consisting of a cover (7), a carriage (6), a base (8) holding two independently adjusted rolling platens (9, 10) that change vertical positions alternatively based on a single and uniquely shaped axle (11), and two specially shaped sliding rails (18), which permit the imprinting head to run along the outside peripheral edges of the flatbed (1). On the top surface of the flatbed, two end caps (3, 4), a middle upward projection (50) and a slit (61) cause the rolling platens to change vertical positions relative to the flatbed and locate precisely the position of the card, the plate and the formset for making the imprint. The present invention is less expensive to manufacture and assemble and has fewer parts and screws than the existing devices. At the same time the invention is robust and provides excellent long lasting imprinting quality.

The invention refers to an imprinting credit card device, which has the potential to imprint, by applying pressure, upon a document (e.g. transaction receipt) the embossed characters of a card (e.g. credit card) and a merchant plate.

The imprinting credit card devices are devices that are found in a variety of retail establishments, which deal in the field of credit buying. The particular devices imprint the embossed alphanumeric characters on a credit card and the vendor's information on a merchant plate, by applying pressure upon a multiple sheet formset (i.e. triple form).

The imprinting credit card devices usually consist of a rectangular flatbed and a movable carriage said imprinting head, which is manually pulled back-and-forth along the surface of the flatbed. The imprinting head comprises one cylinder said rolling platen, mounted on one axle or two cylinders said rolling platens, each mounted on two separate axles and is based upon the flatbed with the use of two sets of wheels, which are located on the outside peripheral edges of the flatbed.

The merchant plate is adjusted permanently onto the top surface of the flatbed and a set of guide fingers is positioned for the credit card and the formset.

Once the formset, said sales slip, is placed within the set of guide fingers, with a hand operated back and forth movement of the imprinting head across the top surface of the formset, the rolling platens press the formset against the credit card and the merchant plate. As a result the credit card's as well as the merchant plate's embossed characters are printed onto the formset.

The merchant plate generally is a rectangular plate and usually having raised embossed characters provides the account number, name, address and in some cases the official sign or symbol of the retail establishment that is making the sale.

The credit card having embossed characters provides information concerning the owner of the card. Such information is the card number, name and address of the purchaser as well as the expiry date of the card and the official sign or symbol of the credit card company.

The formset is a multiple sheet pre-printed formset, having blank spaces. The purpose is to imprint upon the multiple sheet formset the credit card's and merchant plate's correct data, which, in continuation, the credit card company will properly use in order to complete the transaction. The transaction amount is also written usually on the sales slip by pen as well as the signature of the credit card's owner.

The credit card imprinting devices comprise a carriage, which includes one or two rolling platens. In cases where only one rolling platen is used, then with only one sole movement along the base plate the embossed data of both the card and the plate are imprinted upon the formset, with this one movement. In other words there is only one printing cycle. A drawback related to such an imprinter appears when the raised letters of a credit card differ in height, even slightly from those of the merchant plate. In such a case the imprinting of data, resulting either from the card or the plate will not be one of high quality. The above problem can be dealt with the adjustment of two different rolling platens, which respectively in one direction will imprint the data of the merchant plate and in the opposite direction those of the credit card, upon the formset.

Regarding devices that use two rolling platens, each time the imprinting head changes direction, the rolling platens change respectively. When the imprinting head is pulled over the formset in one direction (usually right) the first rolling platen imprints. At the end of this travel across the flatbed, with the help of a special stop (end), which is located at the end of the flatbed, the specific rolling platen is urged upwards and the other rolling platen is shifted from the upward position to a downward print position. This occurs while the imprinting head is changing direction (traveling left) to return to the starting position. Once the imprinting head has reached the starting point, a second stop (end) forces the rolling platens to change again positions. Thus the latter rolling platen is shifted again upwards and the former downwards. The above procedure guarantees excellent quality in imprinting, even in cases where the card and the plate differ in thickness.

For some devices the users themselves are in position to adjust the distance between each rolling platen and the flatbed with the use of small screws, which exert pressure on the rolling platen's axles. By this way the users can control easily the dark quality of the imprinting, according to the thickness of the formset used. In all these cases, however, the metallic screws gradually wear out the plastic axles, reducing the operational life of the devices and the quality of the imprinting.

Due to many types of merchant plates and formsets of different sizes placed in the market, it is not always feasible to transfer the embossed data of the plate to the correct location of the formset. In order to overcome this problem, imprinter manufacturers drill many apertures on the surface of the flatbed, offering thus the potential to position, with screws, the plate at different locations, so as to transfer the embossed data of the plate to the correct location of the formset. In this way the manufacturing cost increases and the problem still exists because the number of locations offered is limited relative to the existing and future plate-formset combinations.

Usually the credit card imprinting devices are quite rigid constructions in order to be able to imprint properly, when the print pressure is applied, the embossed data from the card and the plate onto the formset. For this reason the flatbed credit card imprinters are quite bulky and heavy. Furthermore, they consist of many plastic and metallic parts, which must be assembled with screws.

Existing imprinting credit card devices are typically manufactured from a number of different plastic and metallic parts, which must be assembled to produce the imprinter. Among the parts which must be assembled together to form an imprinter are a flatbed, a movable carriage, the rolling platens, the axles, the card and formset positioning devices, which are attached to the top surface of the flatbed for locating precisely the position of the card and the formset and the stops (ends), which are attached to the top surface of the flatbed for forcing the rolling platens to change vertical positions relative to the flatbed.

The overall cost of manufacturing imprinters having the aforementioned multipart assembly is increased because of the increased labor, time and number of parts and screws required to assemble the imprinter. Because of the fact that imprinters are widely used and purchased by customers in an extremely cost competitive market, a higher cost places the manufacturer at a large disadvantage to lower cost competition. It is very important for the manufacturer of imprinters to reduce the cost of manufacturing of imprinters in order to meet the competitive situation which exists in the market place today.

A solution regarding the above problems relies on manufacturing a device at a competitive cost, which will be sufficiently robust, providing a long lasting high quality imprinting.

The new invention has a flatbed and a movable carriage manufactured by aluminum, supports the upward and downward shifting of the two cylinders respectively and the user's adjustment of the distance between the rolling platens and the flatbed and offers the user the flexibility to position, with movable screws, the plate at unlimited different locations, so as to transfer the embossed data of the plate to the correct location of the formset. The present invention is less expensive to manufacture and assemble and has fewer parts and screws than the existing devices. The device is very rigid and provides high quality printing for long lasting usage, irrespective the thickness of the card or the plate. At the same time, it is very easy to use and it is very robust to user's inappropriate treatment (accidentally dropped or damaged).

### BRIEF DESCRIPTION OF THE DRAWINGS

FIG. 1 illustrates a top plan view of the single piece aluminum flatbed.

FIG. 2 illustrates a sectional view of the flatbed of FIG. 1, taken along section lines A-A.

FIG. 3 illustrates a top plan view of the single piece skirt.

FIG. 4 illustrates a side view of the single piece skirt of FIG. 3.

FIG. 5 illustrates a bottom plan view of the first plastic end cap, which locates precisely the position of the card.

FIG. 6 illustrates a side view of the first plastic end cap of FIG. 5.

FIG. 7 illustrates a top plan view of the first plastic end cap of FIG. 5.

FIG. 8 illustrates a sectional view of the first plastic end cap of FIG. 5, taken along section lines A-A.

FIG. 9 illustrates a sectional view of the first plastic end cap of FIG. 5, taken along section lines B-B.

FIG. 10 illustrates a top plan view of the second plastic end cap, which locates precisely the position of the plate and the formset.

FIG. 11 illustrates a side view of the second plastic end cap of FIG. 10.

FIG. 12 illustrates a bottom plan view of the second plastic end cap.

FIG. 13 illustrates a sectional view of the second plastic end cap of FIG. 12, taken along section lines B-B.

FIG. 14 illustrates a sectional view of the second plastic end cap of FIG. 12, taken along section lines A-A.

FIG. 15 illustrates a sectional view of the assembled imprinting head.

FIG. 16 illustrates a bottom plan view of the assembled imprinting head of FIG. 15.

FIG. 17 illustrates a sectional view of the base taken along section lines A-A.

FIG. 18 illustrates a sectional view of the base taken along section lines B-B.

FIG. 19 illustrates a sectional view of the base taken along section lines B-B on the opposite side.

FIG. 20 illustrates a top plan view of the one out of the two identical sliding rails.

FIG. 21 illustrates a bottom plan view of the sliding rails of FIG. 20.

FIG. 22 illustrates a side view of the sliding rails of FIG. 20.

FIG. 23 illustrates a side view of the carriage.

FIG. 24 illustrates a top plan view of the carriage of FIG. 23.

FIG. 25 illustrates an end view of the carriage of FIG. 23.

FIG. 26 illustrates a side view of the plastic cap.

FIG. 27 illustrates a top plan view of the plastic cap of FIG. 26.

FIG. 28 illustrates a bottom plan view of the plastic cap of FIG. 26.

FIG. 29 illustrates an end view of the plastic cap of FIG. 26.

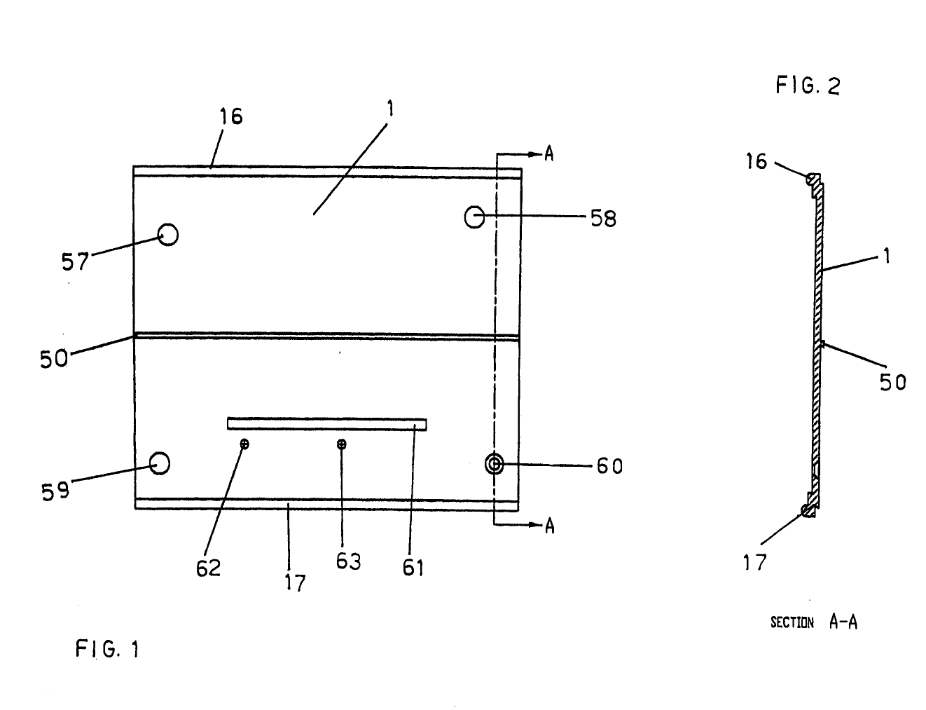

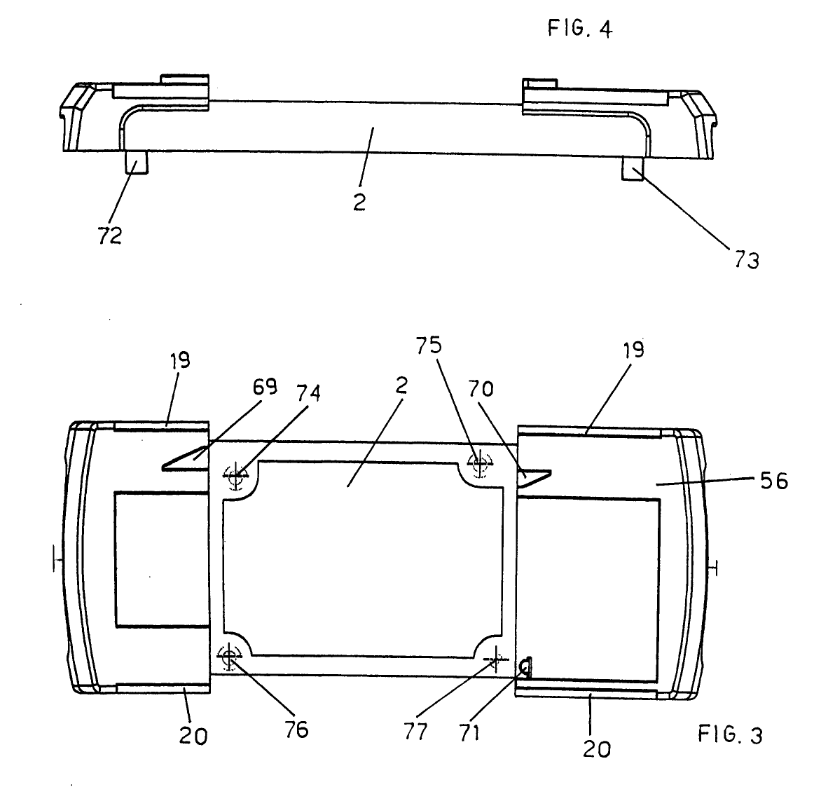

### DETAILED DESCRIPTION OF THE INVENTION'S SUGGESTED MODEL

This particular credit card imprinting device consists of a flatbed (1), made of an extruded piece of aluminum, a single piece skirt (2), which is preferably plastic, having an inside periphery for receiving the flatbed to form a unitary structure of the flatbed and the skirt and a movable imprinting head (5), moving manually in a reciprocal motion across the top surface of the flatbed, consisting of a specially shaped metallic carriage (6) on which a specially shaped plastic base (8) holding two independently adjusted rolling platens (9, 10) that change position alternatively based on a single and uniquely shaped axle (11), and two specially shaped sliding rails (18), which permit the imprinting head to run along the outside peripheral edges (16, 17) of the flatbed, are attached.

The shape of the flatbed (1) is preferably rectangular, having its two outside peripheral edges (16, 17) specially shaped having their upper surface flat and their lower surface in a hemispherical shape, so as to match the outside peripheral edges of the skirt (19, 20) permitting thus the two sliding rails (18) of the imprinting head (5) to run across the edges of the skirt and the flatbed in an unhindered motion. Along the top surface of the flatbed (1), there is a middle upward projection (50), which defines the card's position (card receiving area) and holds the card during imprinting. The flatbed (1) is attached to the single piece skirt (2) with the three spigots (64, 65, 68) of the two plastic end caps (3, 4), which project through the spigot apertures of the flatbed (57, 58, 59) and the spigot apertures of the skirt (74, 75, 76), and a screw (60) inserted through the aperture of the flatbed (60) and the aperture of the skirt (77). The two plastic end caps (3, 4) are set on top of the flatbed (1) and by pressure the three spigots (64, 65, 68) are inserted through the spigot apertures of the flatbed (57, 58, 59) and the spigot apertures of the skirt (74, 75, 76) to the bottom surface of the skirt.

At one side of the flatbed, close to the small plastic end cap (4), maintaining its distance from the outside peripheral edge of the flatbed (17) there is a specially formed long—narrow slit (61), through which the plate is located at unlimited different positions on the flatbed (1) with the use of two free to move screws (not illustrated). Beside the long—narrow slit (61) two drilled apertures (62, 63) are used to locate, with screws, the plate to an alternative firm position.

The single piece skirt (2), preferably made from a molded plastic, has a periphery which extends outside the flatbed (1) and outside the two plastic end caps (3, 4) attached on the top surface of the flatbed, and a plurality of projections (56, 69, 70, 71), extending upwards, defining the formset receiving area for holding the formset during imprinting and forcing the rolling platens to change vertical positions relative to the flatbed.

The shape of the skirt (2) is preferably rectangular, having its two outside peripheral edges (19, 20) specially shaped having their upper surface flat and their lower surface in a hemispherical shape, so as to match the outside peripheral edges of the flatbed (16, 17) permitting thus the two sliding rails (18) of the imprinting head (5) to run across the edges of the skirt and the flatbed in an unhindered motion.

The single piece skirt (2) has four projections (72, 73), located respectively at corners of the skirt, which respectively receive individual feet to support and stop travel the imprinter on a flat surface during imprinting. The skirt further has four apertures (74, 75, 76, 77) for the assembly of the flatbed (1) and the two plastic end caps (3, 4).

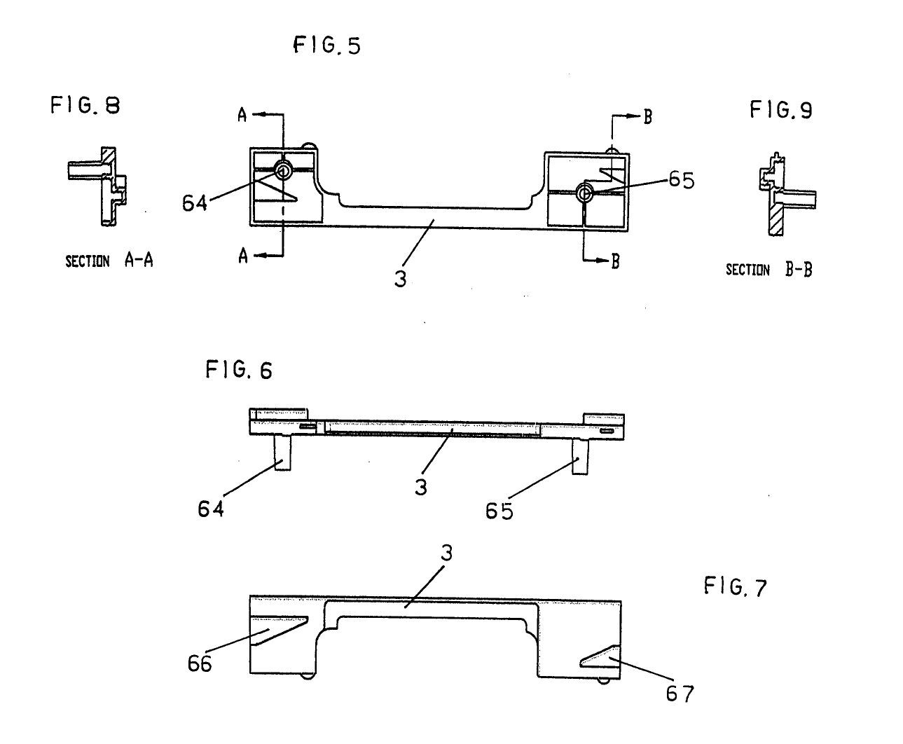

The long end cap (3), illustrated in FIGS. 5, 6, 7, 8, and 9, attached on the top surface of the flatbed (1) with the two spigots (64, 65) inserted through the spigot apertures of the flatbed (57, 58) and the spigot apertures of the skirt (74, 75), defines the card receiving area and the formset receiving area for holding the card and the formset during imprinting and forces, with the two projections (66, 67) matching respectively the two projections (69, 70) of the skirt, the rolling platens (9, 10) to change vertical positions relative to the flatbed.

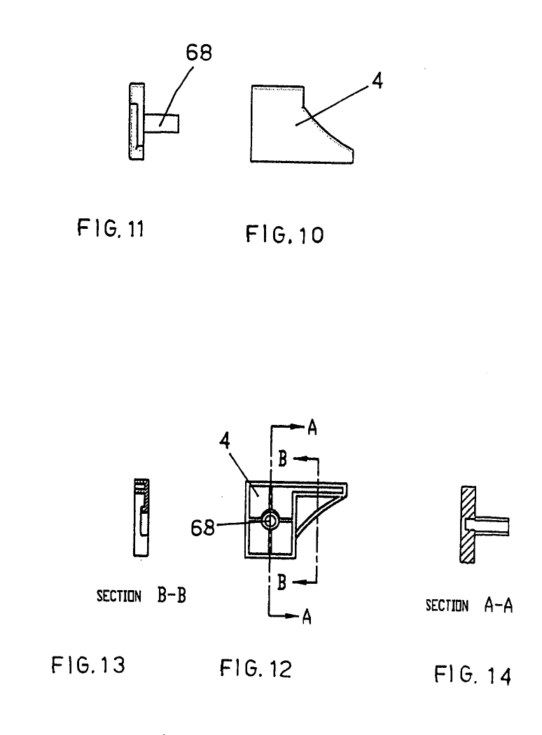

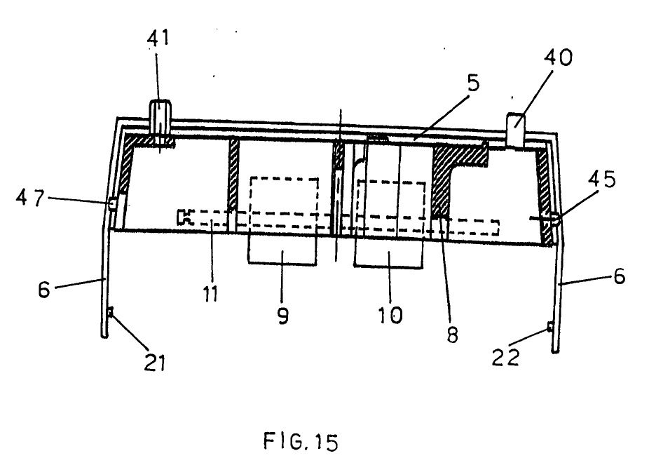

The small end cap (4), illustrated in FIGS. 10, 11, 12, 13 and 14, attached on the top surface of the flatbed (1) with a spigot (68) inserted through the spigot aperture of the flatbed (59) and the spigot aperture of the skirt (76), defines the plate receiving area and the formset receiving area to securely position the formset during the movements of the imprinting head (5).

Along the length of the outside peripheral edges of the flatbed (16, 17) and the skirt (19, 20), slides the imprinting head (5), being at the same time perfectly fastened to the flatbed and the skirt. The imprinting head (5) consists of three special geometrical shape parts, being the carriage (6), the base (8) and the cover (7) that are bound together by two screws (40, 41), two sliding rails (18), attached on the edges of the carriage (21, 22) and two rolling platens (9, 10) mounted on an axle (11), which is retained by the base (8).

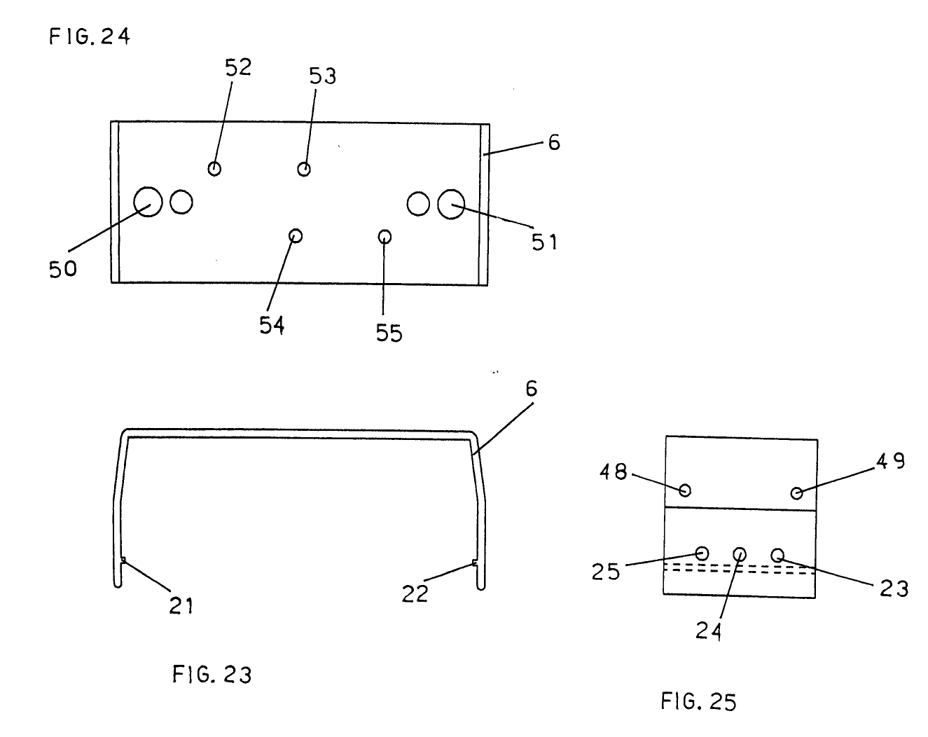

The movable carriage (6), illustrated in FIGS. 23, 24 and 25 is formed from specially shaped integral piece of extruded metal, which is preferably aluminium.

The shape is such as to match exactly the shape of the base (8), which is attached under the carriage with its two spigots (40, 41) inserted through the apertures (50, 51) of the carriage. The carriage has a pair of downwardly extending sides, with each downwardly extending side having an inward projection (21, 22) extending along the side, as illustrated in FIG. 25, and three drilled apertures (23, 24, 25) used to hold and locate precisely the position of the two sliding rails (18). Each downwardly extending side also has two drilled apertures (48, 49), in which the two spigots (44, 45 or 46, 47 respectively) of the base (8) are inserted to securely position and hold the base to the carriage.

The carriage has on the top surface four drilled apertures (52, 53, 54, 55) through which the four screws that control the distance between the rolling platens (9, 10) and the flatbed (1) are inserted.

The base (8), made of only one integral specially shaped piece of plastic, has four side walls (78, 79, 80, 81) and three vertical walls (82, 83, 84) extending inward from one side wall (78) to the other (79), forming thus a bed, for the placement of the axle (11) and the two rolling platens (9, 10). The vertical walls (82, 83, 84) have on the top specially formed grooves (12, 13, 14, 15), in which the axle (11) is secured and leave between them enough space for the rolling platens (9, 10) to move freely.

Three projections (37, 38, 39) extending inwardly from the wide side walls (78, 79) hold the axle (11) and provide a three point suspension of the rolling platens so as to easily adjust them to a preset height with the use of four screws inserted through the four apertures (12, 13, 14, 15) along the three walls (82, 83, 84) from top down to the axle. The correct vertical position of the rolling platens (9, 10) is important in producing a high quality imprinting. The four screws are not in direct touch with the axle, but in between them inside the four apertures (12, 13, 14, 15), four plastic sticks are inserted (not illustrated) to protect the axle being damaged by the screws.

The base (8) has two spigots (40, 41) which extend upwardly and which are inserted through the spigot apertures (50, 51) of the carriage (6) into the spigot apertures (42, 43) of the cover (7). These spigots (40, 41) have internal apertures for the insertion of screws from the top of the cover (7), through spigot apertures (42, 43) thus securing the assembly of the base to the carriage and to the cover.

On each of the narrow side walls (80, 81) of the base (8), there are two projections (44, 45 or 46, 47 respectively), which are inserted to the apertures (48, 49) of the carriage (6) to securely position and hold firmly the base to the carriage.

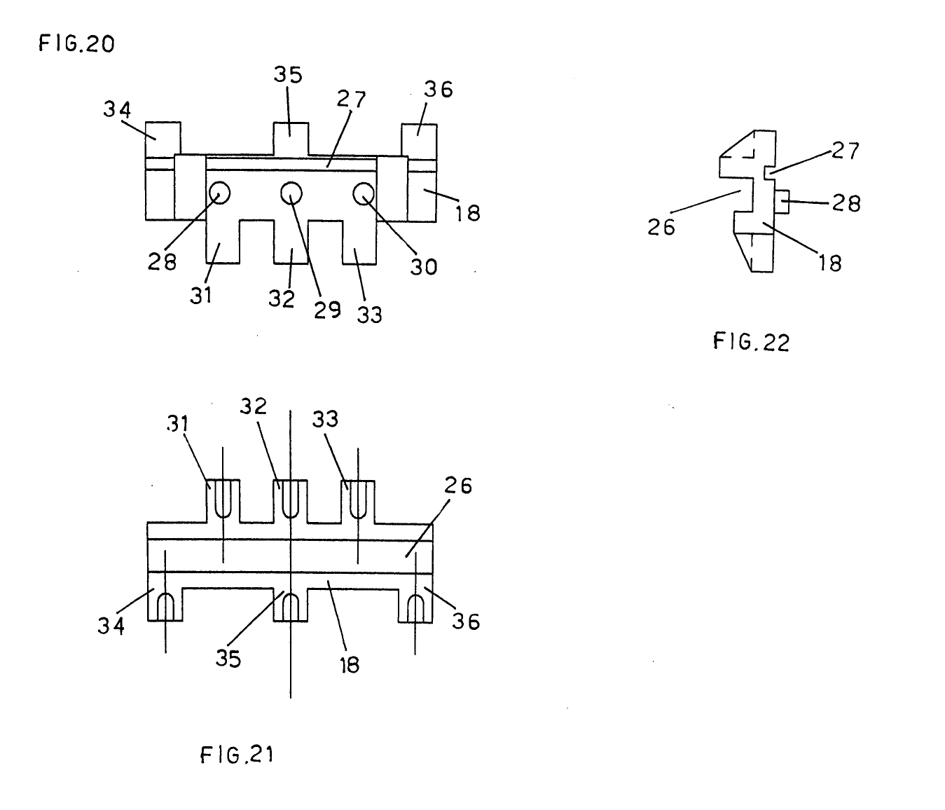

The imprinting head (5) is attached on the outside peripheral edges (16, 17) of the flatbed (1) with the use of two sliding rails (18). Each of the two specially shaped sliding rails (18), as illustrated in FIGS. 20, 21 and 22, preferably made of a plastic material, has along the length of its internal side a specially formed groove (26), in which the outside peripheral edges of the flatbed (16, 17) are inserted and also has along the length of its external side another groove (27), in which the projections (21, 22) of the carriage (6) are inserted. Each of the sliding rails (18) further has spigots (28, 29, 30) on the external side, which insert in the spigot apertures (23, 24, 25) of the carriage and have projections extending upwards (31, 32, 33) and downwards (34, 35, 36), which help the sliding rails to stand firmly and securely on the carriage.

The imprinting head (5) carries two rolling platens (9, 10), which respectively imprint the embossed characters from the credit card by moving the imprinting head in a first direction and the embossed characters from the merchant plate in a second direction opposite the first direction. Thus completion of imprinting requires a forward and reverse stroke.

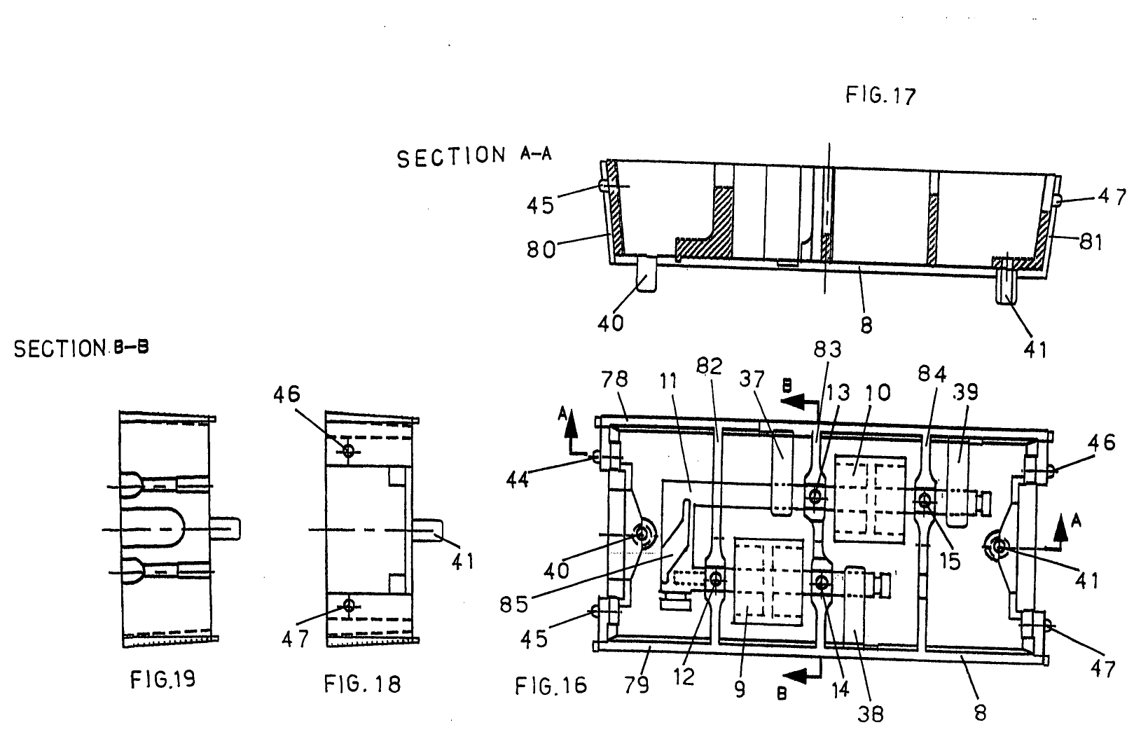

The two rolling platens (9, 10) are mounted on an axle (11), being in fact a pair of parallel axles in one piece having a special geometrical c-shape, as illustrated in FIG. 16. Each rolling platen is mounted upon each parallel axle respectively. The axle (11) has the potential to move right and left while its projection (85) is pressured by the projections (66, 67) of the long end cap (3), causing by this way the rolling platens to change vertical positions relative to the flatbed, that means the rising of one of the rolling platens and simultaneously the lowering of the other.

While the imprinting head (5) reaches the end of its movement along the flatbed, the axle's special projection (85) meets the projection (stop) of the long end cap (66) and brings the first rolling platen (9) from idle to printing position. In other words it causes the second rolling platen (10) to rise slightly and the first rolling platen (9) to lower from the upward position to a downward print position. While the imprinting head (5) moves towards the opposite direction and reaches the end of its movement, the axle's special projection (85) meets the other projection (stop) of the long end cap (67) and brings now the second rolling platen (10) from idle to printing position. In other words it causes the first rolling platen (9) to rise slightly and the second rolling platen (10) to lower from the upward position to a downward print position.

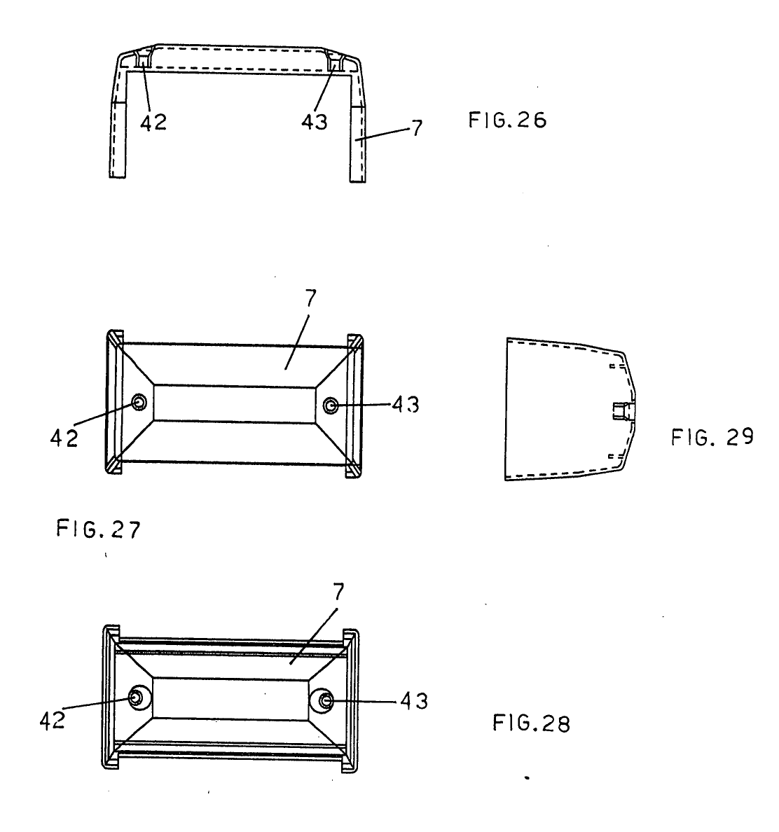

The cover (7) of the imprinting head (5), illustrated in FIGS. 26, 27, 28 and 29, preferably made from molded plastic, is used to cover the carriage and to write upon it personal information of the manufacturer or the customer. The cover is centered as well as connected with the carriage (6) and the base (8), with the use of two screws inserted through the apertures (50, 51) of the carriage into the spigots (40, 41) of the base.

The manufacturing cost of the aforementioned invention is lower as a consequence of the simplification and acceleration of the assembly process and the lower number of parts and screws needed for the assembly. While the assembly process is simplified, fewer parts are required and the cost of manufacturing is lower, with respect to existing devices, whereas the overall functionality of the imprinter is identical to the existing devices.

While a preferred embodiment of the invention, as illustrated above, is a credit card imprinting device, it should be understood that the present invention is not limited to credit card imprinters, with the invention also having utility for other types of imprinting devices, where multiple page formsets are imprinted with characters embossed on one or more cards.

While only a single suggested model of the invention has been described, it should be understood that in practice many variations might be made without thereto departing from the spirit and scope of the invention, as defined in the appended claims. It is intended that all such variations fall within the scope of the appended claims.

1. An imprinter for use in imprinting a formset with embossed data from a credit card and a merchant plate, with pressure applied, comprising: a flatbed (1) preferably made of an extruded piece of aluminum having a middle upward projection (50), which holds the card during imprinting; a single piece skirt (2) on which the flatbed is attached to form a unitary structure of the flatbed and skirt, having a top surface for supporting the card, plate and formset during imprinting; two plastic end caps (3, 4), adjusted on the flatbed, defining a card and a plate receiving surface areas and causing the rolling platens (9, 10) to change vertical positions relative to the flatbed; and an imprinting head (5), attached on the flatbed, moving across the top surface of the flatbed in a back and forward motion and consisted of a carriage (6), a plastic cover (7), a base (8) holder of two rolling platens (9, 10), which have the potential to change vertical positions alternatively based on a single and uniquely shaped axle (11) and which are adjusted to a preset height with the aid of four screws (12, 13, 14, 15), and two specially shaped sliding rails (18), which permit the imprinting head (5) to run along the outside peripheral edges (16, 17) of the flatbed.

2. A credit card imprinting device in accordance with claim 1 wherein: the imprinting head (5) is attached on the outside peripheral edges (16, 17) of the flatbed (1) with the use of two sliding rails (18).

3. A credit card imprinting device in accordance with claim 1 wherein: the flatbed (1) has its two outside peripheral edges (6, 17) specially shaped, with their upper surface flat and their lower surface in a hemispherical shape, so as to match the outside peripheral edges of the skirt (19, 20) and the internal groove (26) of the sliding rails (18), permitting thus the two sliding rails (18) of the imprinting head (5) to run across the edges of the skirt and the flatbed in an unhindered motion.

4. A credit card imprinting device in accordance with claim 1 wherein: the flatbed (1) has, close to the small plastic end cap (4), maintaining its distance from the outside peripheral edge (17) of the flatbed a specially formed long—narrow slit (61), through which the plate is located at unlimited different positions on the flatbed (1) with the use of two free to move screws.

5. A credit card imprinting device in accordance with claim 2 wherein: each specially shaped sliding rail (18), preferably made of a plastic material, has along the length of its internal side a specially formed groove (26), in which the outside peripheral edges (16, 17) of the flatbed are inserted, and also has along the length of its external side another groove (27), in which the projections (21, 22) of the carriage are inserted.

6. A credit card imprinting device in accordance with claim 2 wherein: each specially shaped sliding rail (18), has spigots (28, 29, 30) on the external side, which insert in the spigot apertures (23, 24, 25) of the carriage and also has projections extending upwards (31, 32, 33) and downwards (34, 35, 36), which help the sliding rail to stand firmly and securely on the carriage (6).

7. A credit card imprinting device in accordance with claim 1 wherein: the carriage (6), made of one specially shaped integral piece of aluminum, has a pair of downwardly extending sides, with each downwardly extending side having an inward projection (21, 22) extending along the side and drilled apertures (23, 24, 25) used to hold and locate precisely the position of the two sliding rails (8).

8. A credit card imprinting device in accordance with claim 7 wherein: each downwardly extending side of the carriage (6) has two drilled apertures (48, 49), in which the two spigots (44, 45 or 46, 47 respectively) of the base (8) are inserted to securely position and hold the base to the carriage.

9. A credit card imprinting device in accordance with claim 1 wherein: the base (8), made of only one specially shaped piece of plastic, forming a bed for the placement of the axle (11) and the two rolling platens (9, 10), has four side walls (78, 79, 80, 81) and three vertical walls (82, 83, 84) extending inward from one side wall (78) to the other (79), having on the top specially formed grooves (12, 13, 14, 15), in which the axle (11) is secured and leave between them enough space for the rolling platens (9, 10) to move freely.

10. A credit card imprinting device in accordance with claim 9 wherein: the base (8) has three projections (37, 38, 39) extending inwardly from the wide side walls (78, 79) holding the axle (11) and providing a three point suspension of the rolling platens so as to easily adjust them to a preset height with the use of four screws inserted through the four apertures (12, 13, 14, 15) along the three walls (82, 83, 84) from top down to the axle.

11. A credit card imprinting device in accordance with claim 9 wherein: on each of the narrow side walls (80, 81) of the base (8), there are two projections (44, 45 or 46, 47 respectively), which are inserted to the apertures (48, 49) of the carriage (6) to securely position and hold firmly the base to the carriage.

12. A credit card imprinting device in accordance with claim 10 wherein: the four screws are not in direct touch with the axle (1), but in between them inside the four apertures (12, 13, 14, 15), four plastic sticks are inserted to protect the axle being damaged by the screws.
